(19) United States
(12) Patent Application Publication
(10) Pub. No.: US 2019/0363482 A1
(43) Pub. Date: Nov. 28, 2019

(54) CHARGING INLET

(71) Applicant: Sumitomo Wiring Systems, Ltd., Yokkaichi, Mie (JP)

(72) Inventor: Masato Kamemura, Yokkaichi, Mie (JP)

(21) Appl. No.: 16/461,827

(22) PCT Filed: Nov. 7, 2017
(86) PCT No.: PCT/JP2017/040041

§ 371 Date: May 17, 2019

(30) Foreign Application Priority Data
Nov. 21, 2016 (JP) 2016-225849

(51) Int. Cl. H01R 13/52; H01R 13/73; H01R 13/424

(52) U.S. Cl. CPC H01R 13/5202; H01R 2201/26; H01R 13/424; H01R 13/73

(57) ABSTRACT

A charging inlet (10) includes a plate (50) has vehicle fastening portions (55) to be fixed to a body (90) of a vehicle and a connector insertion hole (51) in a region surrounded by the vehicle fastening portions (55). The charging inlet (10) further includes an inlet body (20) that has a connector fitting (22) and that is fixed to the plate (50). The connector fitting (22) is inserted through the connector insertion hole (51). An annular sealing member (80) is disposed on an outer peripheral side of the connector insertion hole (51) and is sandwiched between the plate (50) and the inlet body (20).

### BACKGROUND

### Field of the Invention

This specification relates to a charging inlet.

### Related Art

Japanese Unexamined Patent Publication No. 2015-99764 discloses a vehicle-side connector to which a charging connector connected to a charger is connectable from the front. The vehicle-side connector includes a housing body having a fitting tube to which the charging inlet is fit, an LED display device having an insertion hole through which the fitting tube is insertable and a packing sandwiched between the housing body and the LED display device. Flange-like mounting portions are formed on the outer periphery of the housing body. These mounting portions project from four corners of the outer peripheral surface of the housing body, and collars are embedded in projecting end parts of the respective mounting portions. The housing body is fixed to a body of a vehicle by inserting bolts through these collars and fastening the bolts to a vehicle side.

However, fastening positions on the vehicle side differ depending on vehicle types. Thus, the positions of the mounting portions need to be changed for each vehicle type. However, dimensional accuracy required for the housing body is very strict. Thus, if the positions of the mounting portions are changed, the housing body needs to be dimensioned each time and a manufacturing burden is large.

### SUMMARY

A charging inlet disclosed in this specification includes a plate having vehicle fastening portions to be fixed to a body of a vehicle and a connector insertion hole provided in a region surrounded by the vehicle fastening portions. The charging inlet also includes an inlet body having a connector fitting fixed to the plate. The connector fitting is inserted through the connector insertion hole. An annular sealing member is disposed on an outer peripheral side of the connector insertion hole and is sandwiched between the plate and the inlet body.

According to this configuration, the charging inlet is mounted on the body of the vehicle by fastening the vehicle fastening portions to the body of the vehicle after the inlet body is fixed to the plate. In accordance with the invention, it is sufficient merely to change the positions of the vehicle fastening portions of the plate if fastening positions on the vehicle side differ depending on vehicle types. Thus, the shape of the inlet body required to have strict dimensional accuracy need not be changed, and time and labor for dimensioning can be saved. Therefore, a manufacturing burden can be reduced. As just described, the fastening positions different for each vehicle can be dealt with flexibly by sharing the inlet body.

The connector fitting may include a hollow cylindrical peripheral wall, a terminal accommodating portion provided on an inner peripheral side of the peripheral wall and a lock provided on an outer peripheral surface of the peripheral wall. The connector insertion hole may include a peripheral wall accommodation space for accommodating the peripheral wall and a lock accommodation space for accommodating the lock. According to this configuration, the plate is not present around the lock before the inlet body and the plate are assembled. Thus, the plate is not in the way when a mold for molding the lock is removed. Further, the lock accommodation space and the peripheral wall accommodation space can be formed into a single connector insertion hole and the configuration of the plate can be simplified.

The inlet body may be provided with escaping portions at positions corresponding to the vehicle fastening portions. According to this configuration, the interference of shafts of bolts with the inlet body can be avoided when the bolts are fastened to the vehicle fastening portions.

According to the charging inlet disclosed by this specification, fastening positions different for each vehicle can be dealt with flexibly by sharing the inlet body.

### BRIEF DESCRIPTION OF THE DRAWING

FIG. 1 is a perspective view of a charging inlet obliquely viewed from front.

FIG. 2 is an exploded perspective view showing constituent components of the charging inlet.

FIG. 3 is a front view of the charging inlet.

FIG. 4 is a side view of the charging inlet.

FIG. 5 is a side view partly in section showing a state where the charging inlet is fixed to a body of a vehicle.

FIG. 6 is a back view of the charging inlet.

FIG. 7 is a front view of an inlet body.

FIG. 8 is a side view of the inlet body.

FIG. 9 is a bottom view of the inlet body.

FIG. 10 is a section along A-A in FIG. 7.

FIG. 11 is a section along B-B in FIG. 8.

### DETAILED DESCRIPTION

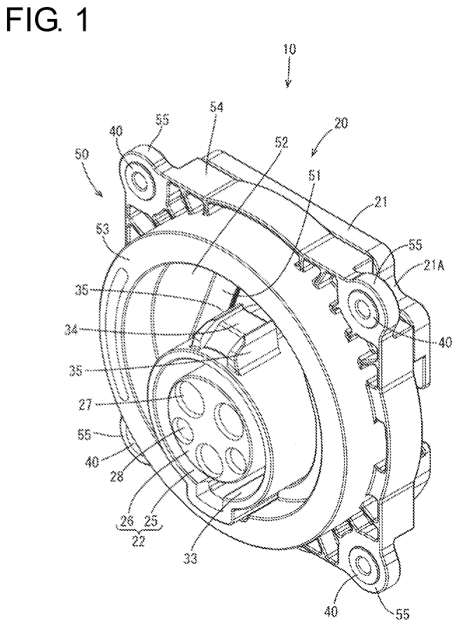

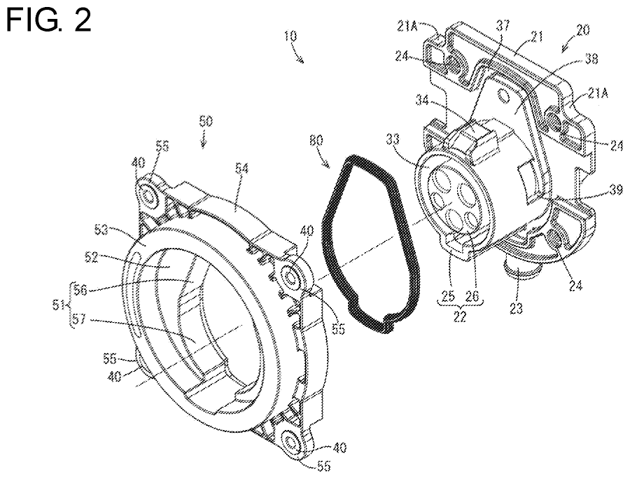

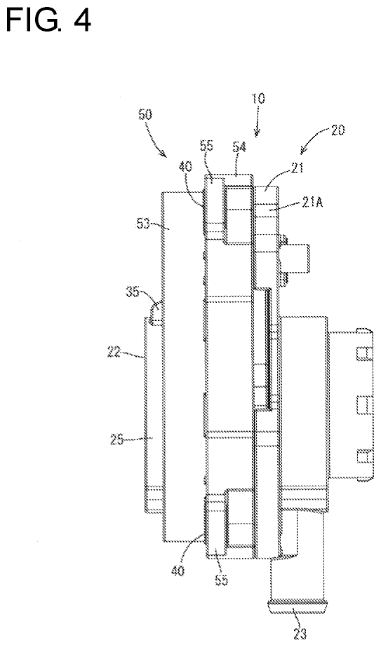

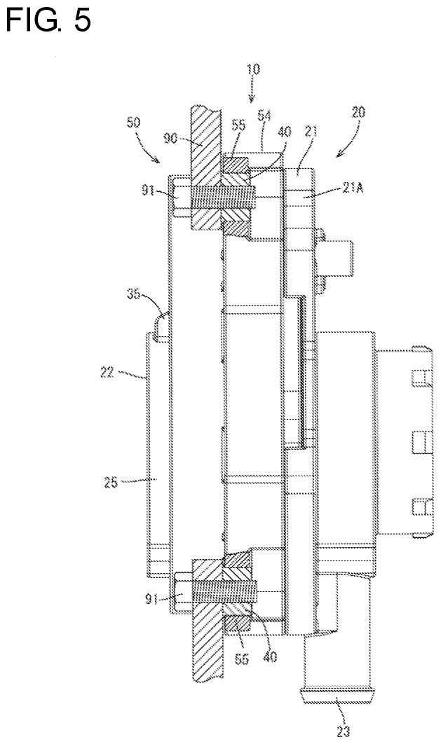

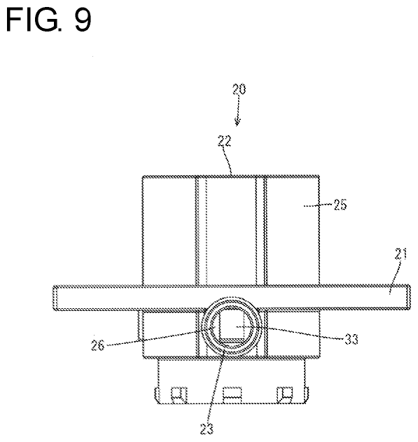

An embodiment is described on the basis of FIGS. 1 to 11. A charging inlet 10 in this embodiment includes, as shown in FIGS. 1 and 2, an inlet body 20, a holding plate (hereinafter, referred to as a “plate”) 50 and a sealing member 80. The charging inlet 10 is mounted on a body 90 of a vehicle in posture to face obliquely up. However, to facilitate understanding, a state where the charging inlet 10 is attached in a horizontal posture on the body 90 is shown in FIG. 5. A battery equipped in the vehicle is charged by connecting a charging gun connected to a charger to the charging inlet 10.

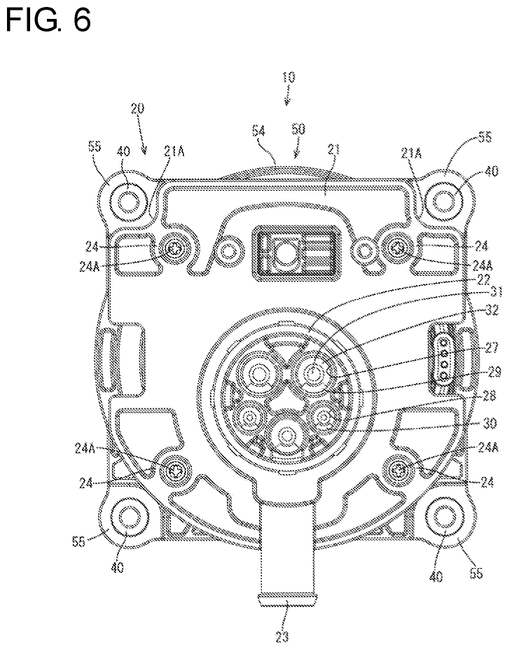

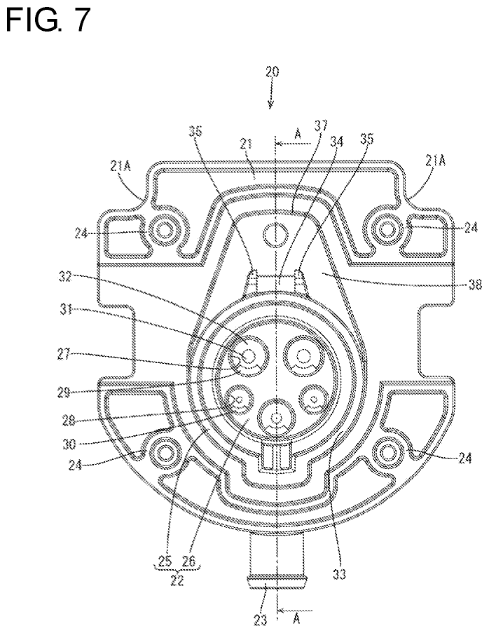

The inlet body 20 is made of synthetic resin and includes a base plate 21, a connector fitting 22 formed to penetrate through the base plate 21 in a front-rear direction and a tubular drain 23 provided to project downward from a part of the connector fitting portion 22 projecting rearward of the base plate 21. As shown in FIG. 7, fixing portions 24 are provided on an outer peripheral side of the base plate 21. As shown in FIG. 6, the plate 50 is mounted and fixed to the inlet body 20 by inserting bolts 24A through the fixing portions 24 and tightening the bolts 24A into the plate 50.

As shown in FIG. 7, the connector fitting 22 includes a peripheral wall 25, a terminal accommodating portion 26 provided inside the peripheral wall 25 and a lock 34 provided on an outer peripheral upper surface of the peripheral wall 25. The terminal accommodating portion 26 is in the form of a block that is circular when viewed from the front. Large and small cavities 27, 28 penetrate in the front-rear direction inside the terminal accommodating portion 26. Large terminals (not shown) for large current are accommodated in the large cavities 27 and small terminals (not shown) for communication are accommodated in the small cavities 28. Two types of drainage holes 29, 30 are provided in lower end parts of the respective cavities 27, 28 and are arcuate when viewed from the front.

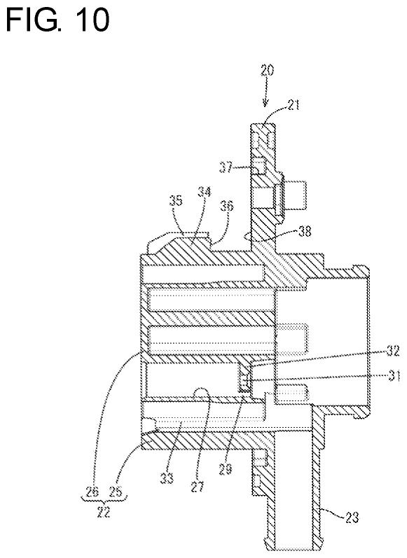

As shown in FIG. 10, the large drainage hole 29 is provided in a lower part of a terminal supporting wall 32 provided with a terminal insertion hole 31. On the other hand, a fitting space 33 into which a receptacle (not shown) provided on the charging gun is fit is provided between the inner peripheral surface of the peripheral wall 25 and the outer peripheral surface of the terminal accommodating portion 26. The fitting space 33 communicates with the large cavities 27 and also with an internal space of the drain 23. Thus, water that has intruded into the large cavities 27 flows into the fitting space 33 through the large drainage holes 29 and is drained to outside through the internal space of the drain 23 from the fitting space 33. Note that since the small cavities 28 also have a drainage structure similar to that of the large cavities 27, the small cavities 28 are not described here.

As shown in FIG. 7, two lock protection walls 35 are provided integrally on both left and right sides of the lock 34. As shown in FIG. 10, the upper surface of the lock 34 is lower than an upper end of the lock protection wall 35. Further, the rear surface of the lock 34 is formed into an undercut locking surface 36 and projects farther rearward than a rear end part of the protection wall 35. The locking surface 36 of the lock 34 is formed by laterally removing a mold when the inlet body 20 is molded, and it is not necessary to remove the mold rearward by providing a mold removal hole rearward of the base plate 21.

As shown in FIG. 7, a mounting groove 37 surrounds the peripheral wall 25 and the lock 34 and is configured to receive the sealing member 80. A lower half of the mounting groove 37 is constituted by the outer peripheral surface of the peripheral wall 25 and an upper half thereof is constituted by the outer peripheral surface of a pedestal 38 coupled to the rear end of the lock 34. An upper edge and both left and right side edges of the pedestal 38 are formed into a substantially U-like outer peripheral shape when viewed from the front, and a lower edge of the pedestal 38 is formed into an arcuate recess extending along the outer peripheral upper surface of the peripheral wall 25.

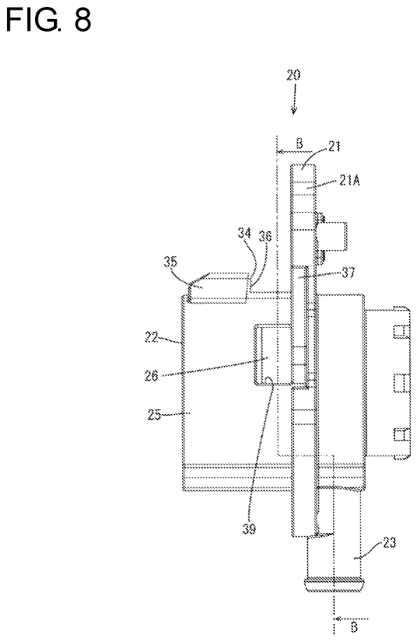

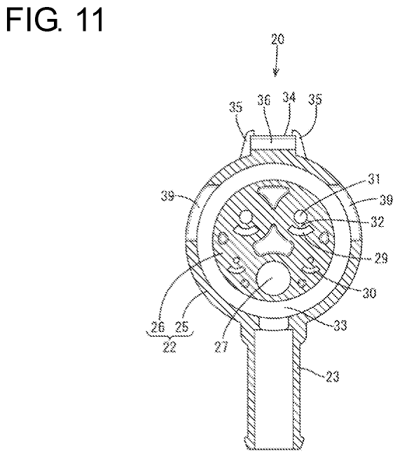

As shown in FIG. 8, a drainage port 39 is provided in an outer peripheral side surface of the peripheral wall 25. The drainage port 39 has a rectangular shape vertically long when viewed laterally. Further, the drainage port 39 is formed by laterally removing the mold when the inlet body 20 is molded. The front edge of the drainage port 39 substantially aligns with the locking surface 36 of the lock 34 in the front-rear direction, and the rear edge thereof is at a position in contact with the front surface of the base plate 21. As shown in FIG. 11, the drainage port 39 communicates with the fitting space 33 of the connector fitting 22. Thus, water having intruded into the fitting space 33 along the outer peripheral surface of the peripheral wall 25 and from the drainage ports 39 flows down along the inner peripheral surface of the peripheral wall 25 and is drained to outside through the internal space of the drain 23.

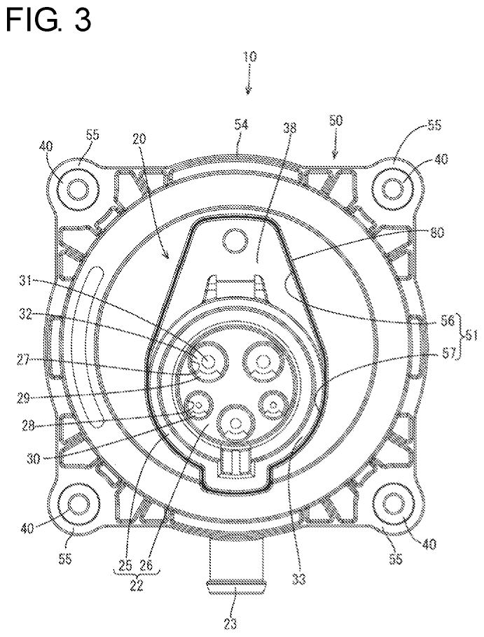

The plate 50 is made of synthetic resin and includes, as shown in FIG. 2, a connector insertion hole 51 through which the connector fitting portion 22 is inserted. As shown in FIG. 3, the connector insertion hole 51 is configured as a single hole to which the connector fitting portion 22 and the pedestal portion 38 conform to be fittable. In particular, the connector insertion hole 51 is divided into a peripheral wall accommodation space 56 having the peripheral wall 25 accommodated therein and a lock portion accommodation space 57 having the lock portion 34 accommodated therein. The aforementioned drainage ports 39 are provided in a lower end part of the lock portion accommodation space 57 in the outer peripheral surface of the peripheral wall 25, i.e. a pair of left and right drainage ports 39 are provided in the outer peripheral side surfaces of the peripheral wall 25. When the inlet body 20 and the plate 50 are assembled, the sealing member 80 fit on the outer peripheral surfaces of the pedestal portion 38 and the peripheral wall 25 is sandwiched between these outer peripheral surfaces and the inner peripheral surface of the connector insertion hole 51.

The plate 50 includes an intermediate wall 52 constituting the inner peripheral surface of the connector insertion hole 51, a circular ring-shaped outer tube portion 53 provided around the intermediate wall 52 and an attaching portion 54 provided to protrude outward from the outer peripheral surface of the outer tube portion 53. As shown in FIG. 3, the attaching portion 54 has a substantially square outer peripheral shape when viewed from front, and four vehicle fastening portions 55 are provided on four corners of the attaching portion 54 as shown. A collar 40 made of metal is fixed to each vehicle fastening portion 55. As shown in FIG. 5, the charging inlet 10 is attached and fixed to the body 90 by tightening bolts 91 with the collars 40 made of metal held in contact with the body 90 made of metal (metal touch) and sandwiching the body 90 between head parts of the bolts 91 and the collars 40. Note that, as shown in FIG. 1, a pair of escaping portions 21A for allowing shaft parts of the bolts 91 to escape are provided in upper end corner parts of the base plate portion 21.

This embodiment is configured as described above. Next, functions of this embodiment are described. First, assembling and attaching operations of the charging inlet 10 are briefly described. The sealing member 80 is fit into the mounting groove 37 of the inlet body 20 and the plate 50 is assembled with this inlet body 20. The bolts 24A are inserted into the fixing portions 24 and tightened into the attaching portion 54 of the plate 50. As a result, the sealing member 80 is sandwiched between the inlet body 20 and the plate 50, and the intrusion of water between the inlet body 20 and the plate 50 can be prevented. Thereafter, the charging inlet 10 is attached to the body 90 of the vehicle. The attaching operation is performed by bringing the collars 40 of the vehicle fastening portions 55 of the plate 50 into contact with the body 90 and tightening the bolts 91.

Since the charging inlet 10 is normally used outside the vehicle, rainwater and the like may fall on the charging inlet 10. Water adhering to the periphery of the lock portion 34 flows downward while moving toward the base plate portion 21 (rearward) along the outer peripheral surface of the peripheral wall 25, and enters the fitting space 33 through the drainage ports 39. The water having intruded into the fitting space 33 flows along the inner peripheral surface of the peripheral wall 25 and flows downward along the base plate portion 21, and is drained to the outside of the vehicle through the inside of the drain portion 23. Further, the water having intruded into the cavities 27, 28 enters the fitting space 33 through the drainage holes 29, 30, flows downward along the base plate portion 21 and is drained to the outside of the vehicle through the inside of the drain portion 23. As just described, the water adhering to the charging inlet 10 does not intrude to the inside of the vehicle (side behind the base plate portion 21).

As described above, according to this embodiment, the charging inlet 10 is mounted on the body 90 of the vehicle by respectively fastening the plurality of vehicle fastening portions 55 to the body 90 of the vehicle after the inlet body 20 is fixed to the plate 50. Here, since it is sufficient to change only the positions of the vehicle fastening portions 55 of the plate 50 if the fastening positions on the vehicle side differ depending on vehicle types, the shape of the inlet body 20 required to have strict dimensional accuracy needs not be changed and time and labor for dimensioning can be saved, whereby a manufacturing burden can be reduced. As just described, the fastening positions different for each vehicle can be flexibly dealt with by sharing the inlet body 20.

The connector fitting portion 22 may include the hollow cylindrical peripheral wall 25, the terminal accommodating portion 26 provided on the inner peripheral side of the peripheral wall 25 and the lock portion 34 provided on the outer peripheral surface of the peripheral wall 25, and the connector insertion hole 51 may include the peripheral wall accommodation space 56 for accommodating the peripheral wall 25 and the lock portion accommodation space 57 for accommodating the lock portion 34.

According to this configuration, since the plate 50 is not present around the lock portion 34 in a state before the inlet body 20 and the plate 50 are assembled, the plate 50 does not stand in the way when the mold for molding the lock portion 34 is removed. Further, the lock portion accommodation space 57 and the peripheral wall accommodation space 56 can be formed into a single hole (connector insertion hole 51) and the configuration of the plate 50 can be simplified.

The inlet body 20 may be provided with the escaping portions 21A at the positions corresponding to the vehicle fastening portions 55.

According to this configuration, the interference of the shaft parts of the bolts 91 with the inlet body 20 can be avoided when the bolts 91 are fastened to the vehicle fastening portions 55.

### Other Embodiments

The technique disclosed by this specification is not limited to the above described and illustrated embodiment. For example, the following various modes are also included.

Although the plate 50 is provided with four vehicle fastening portions 55 in the above embodiment, the number of the vehicle fastening portions 55 does not matter.

(2) Although the connector insertion hole 51 includes the peripheral wall accommodation space 56 and the lock portion accommodation space 57 in the above embodiment, a connector insertion hole may include no lock portion accommodation space.

(3) Although the shaft parts of the bolts 91 are prevented from interfering with the base plate portion 21 by providing the inlet body 20 with the escaping portions 21A in the above embodiment, the interference of the shaft parts of the bolts 91 with a base plate portion may be avoided by making the base plate portion one size smaller than the base plate portion 21 of the above embodiment.

### LIST OF REFERENCE SIGNS

10 . . . charging inlet
20 . . . inlet body
21A . . . escaping portion
22 . . . connector fitting portion
25 . . . peripheral wall
26 . . . terminal accommodating portion
34 . . . lock portion
50 . . . holding plate
51 . . . connector insertion hole
55 . . . vehicle fastening portion
56 . . . peripheral wall accommodation space
57 . . . lock portion accommodation space
90 . . . body

1. A charging inlet, comprising:
a plate including a plurality of vehicle fastening portions to be fixed to a body of a vehicle and a connector insertion hole provided in a region surrounded by the plurality of vehicle fastening portions;
an inlet body including a connector fitting and fixed to the plate, the connector fitting being inserted through the connector insertion hole, the connector fitting including a hollow cylindrical peripheral wall and a terminal accommodating portion provided on an inner peripheral side of the peripheral wall, the peripheral wall being provided with a drainage port penetrating between an outer peripheral surface and an inner peripheral surface of the peripheral wall; and
an annular sealing member disposed on an outer peripheral side of the connector insertion hole and sandwiched between the plate and the inlet body.

2. The charging inlet of claim 1, wherein the connector fitting portion includes the peripheral wall, the terminal accommodating portion and a lock provided on the outer peripheral surface of the peripheral wall, and the connector insertion hole includes a peripheral wall accommodation space for accommodating the peripheral wall and a lock accommodation space for accommodating the lock.

3. The charging inlet of claim 2, wherein the inlet body is provided with escaping portions at positions corresponding to the vehicle fastening portions.

4. The charging inlet of claim 1, wherein the inlet body is provided with escaping portions at positions corresponding to the vehicle fastening portions.
